(19) United States
(12) Patent Application Publication
(10) Pub. No.: US 2006/0162909 A1
(43) Pub. Date: Jul. 27, 2006

(54) Heat exchange device for a fiber-drawing booth

(75) Inventors: Xiaoqiang Xu, Chambery (FR); Pierre Deleplace, Yenne (FR); Nicolas Marsault, Vieugy (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SAINT-GOBAIN VETROTEX FRANCE S.A., Chambery (FR)

(21) Appl. No.: 10/541,825

(22) PCT Filed: Jan. 14, 2004
(86) PCT No.: PCT/FR04/00052

§ 371 Date: Mar. 28, 2006

(30) Foreign Application Priority Data
Jan. 15, 2003 (FR) 03/00380

(51) Int. Cl. F28D 1/00; F28D 1/04; C03B 37/10

(52) U.S. Cl. 165/148; 165/151; 65/511

(57) ABSTRACT

A heat exchanger device including at least one fin provided with a mechanism for blowing a fluid. The blowing mechanism includes at least one of the walls of the fin, the at least one of the walls having open porosity.

The present invention relates to improvements made to fiberizing booths intended for the fabrication of glass filaments. It will be recalled that a fiberizing booth is, in a way known per se, made up of at least one bushing pierced with a plurality of holes through which molten glass flows to form a web of glass filaments.

More specifically, the present invention is aimed at a heat exchanger device designed to be positioned underneath the bottom of the bushing, the latter being itself situated within the fiberizing booth.

Now, operating a fiberizing booth is actually a particularly complex process in the course of which numerous physico-chemical parameters are constantly monitored. In this respect, it is pointed out in particular that the temperature at the bottom of the bushing is one of the most important parameters in obtaining an optimum filament as it is actually this that governs the viscosity of the glass.

To this end, it is therefore necessary to cool the underside of the bushing so as to set the temperature of the cones of glass fibers.

Furthermore, other phenomena influence the temperature of the cone of filaments and require the incorporation of heat exchanger devices underneath the bottom of the bushing.

Thus, in a fiberizing booth, the movement of the filaments carries along the air trapped in the web toward the outside of the booth, and this causes air to be sucked from the outside toward the inside of the web underneath the bottom of the bushing. It is necessary to supply fresh air to compensate for this lack of air underneath the bottom of the bushing so as to ensure uniform heat exchange with the glass cones and the bottom of the bushing, thus making it possible to improve the uniformity of the filament thickness.

A first family of known heat exchanger devices which are able to influence the temperature at the bottom of the bushing but do not perform the air supply function consists of an array of fins forming combs. Each of the fins is made of a bar made of a material with excellent heat exchange coefficients (particularly in terms of conduction), one of the free ends of each bar being connected to a manifold secured to the fiberizing booth at the underside of the bushing and provided with a heat transfer circuit thus allowing the heat energy extracted by conduction to be taken away, the glass filaments passing between the gaps of the comb.

Although it meets the current requirements in terms of the cooling of the underside of the bushing, this first family of devices cannot be read across to bushings with a high throughput. Problems associated with the geometry of the fiberizing booths (the dimensions of the area of the booth intended to accommodate the bushing are set by construction) make it difficult to envisage mounting these devices on bushings comprising a great many (several thousand) orifices, this problem being all the more exacerbated when, in addition, additional air needs to be supplied, something that is essential in high-throughput bushings.

Also known is a second family of heat exchanger devices which perform both the function of cooling the cone of glass and the function of supplying air. These are blowing fins. The latter are also configured as a comb and situated underneath the bottom of the bushing, the glass filaments passing through the gaps between the rows of fins.

Cooling fins are known from patents U.S. Pat. No. 3,150,946 and U.S. Pat. No. 3,345,147. Now, according to those documents, the fins are made from a metal gauze which is folded into a tube to form the fin. However, folding deforms some of the holes in the mesh. These are then no longer the same size and the flow generated by blowing is no longer uniform.

Patent U.S. Pat. No. 5,693,118 discloses a suction fin device that increases the convected heat exchange underneath the bottom of the bushing. The sucking of air through the fins generates uniform flow under the bushing and improves the stability of the fiberizing. By contrast, the sucking-in of air through the fins encourages the deposition of airborne substances (dust) on the surface of the fins and the ingress of dust and water droplets into the web, and these are factors known to contribute to the instability of the web.

Patents U.S. Pat. No. 4,214,884 and U.S. Pat. No. 4,310,602 relate to fins made from a thin sheet of solid nickel. The holes, with identical and precise dimensions, are obtained using a photochemical or electrolytic process.

In spite of the care taken in manufacturing these holes, their density is not enough to guarantee the optimum air flow conditions (uniformity) that will guarantee the stability of the web of glass filaments.

The present invention therefore aims to alleviate these disadvantages by proposing a heat exchanger device intended to be positioned underneath the bottom of a bushing, particularly a high-throughput bushing, this heat exchanger device being designed to guarantee optimum fiberizing conditions for the web of filaments passing through said bushing.

To this end, the heat exchanger device that is the subject of the invention, comprising at least one fin provided with means for blowing a fluid, is characterized in that the blowing means are uniform and consist of at least one of the walls of said fin, said wall having open porosity.

By virtue of these arrangements it is possible to obtain optimum cooling of the cone of glass leaving the bottom of the bushing using a convection movement resulting from the blowing of the fluid.

In preferred embodiments of the invention recourse may also possibly be had to one and/or other of the following measures:

the open porosity of the wall is between 5 and 30% and preferably between 10 and 25% and more preferably still between 15 and 20%,

the fin is of parallelepipedal overall shape and tubular cross section and has a permeability measured with air at a pressure of 0.5 bar and at 0° C. lying in the range from 300 to 1500 Sm³/h/m², particularly lying in the range from 300 to 800 Sm³/h/m², and preferably lying in the range between 500 and 600 Sm³/h/m²,

the blowing fluid velocity field is symmetric across the open porosity wall,

at least one of the walls of the heat exchanger device is obtained by sintering a metal powder,

the metal powder is based on a mixture of powdered stainless steel, brass and nickel, with a particle size smaller than 100 μm and preferably with a particle size lying within the range from 10 to 80 μm,

the porosity of the fin based on metal powder is of the order of 17%,

at least one of the walls of the heat exchanger device is obtained by laminating a metal gauze,

the lamination comprises 3 to 18, particularly 3 to 6, layers of metal gauze,

the fluid is air at a pressure of between 0.1 and 6 bar, preferably between 0.2 and 4 bar,

the blowing fluid results from the vaporization within the fin of a fluid that was initially in the liquid state,

the heat exchanger device is provided with an auxiliary cooling circuit.

Other features and advantages of the invention will become apparent in the course of the following description of one of its embodiments, given by way of non-limiting example with reference to the attached drawings. In the drawings:

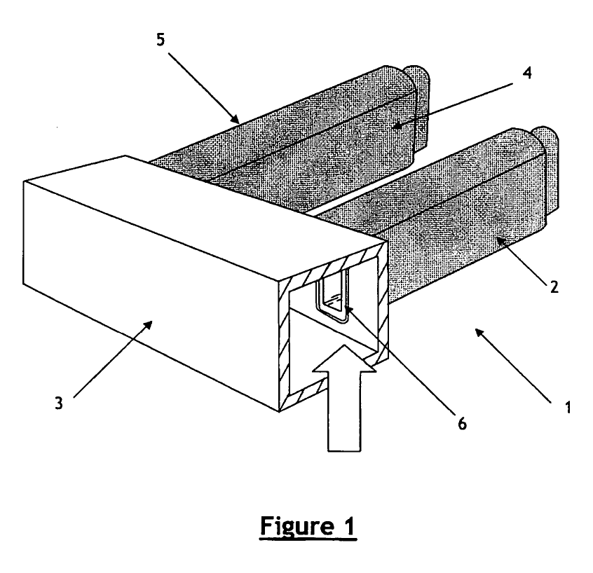

FIG. 1 is a perspective view of a heat exchanger device according to the invention,

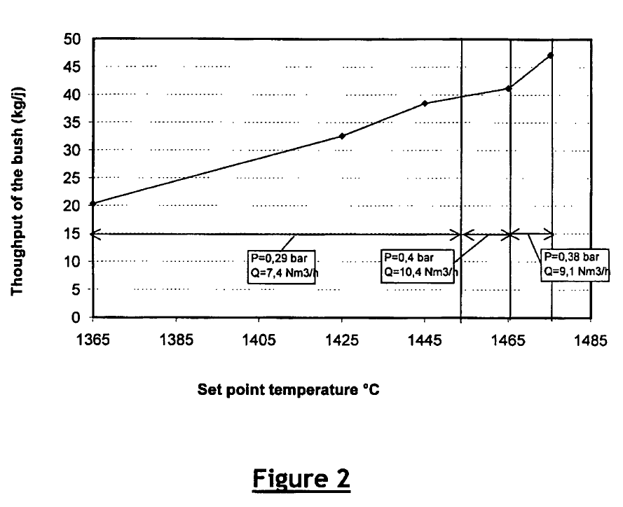

FIG. 2 is a curve illustrating the change in throughput of a bushing as a function of the increase in the set point temperature of the bushing, and for various cooling air flow rates through the fin,

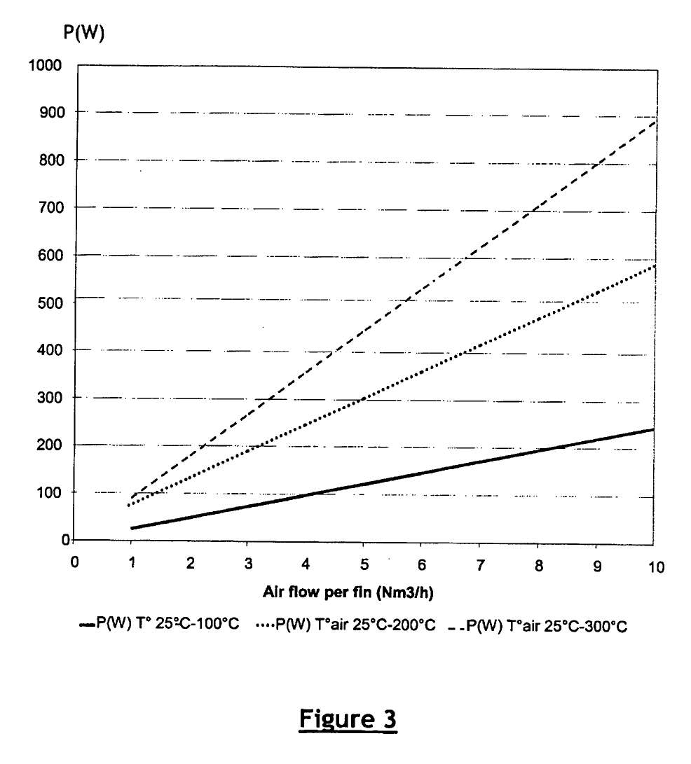

FIG. 3 is a curve illustrating the change in thermal power likely to be removed by a blowing fin as a function of the blowing fluid flow rate and as a function of the temperature difference between a point on the fin and the blown air,

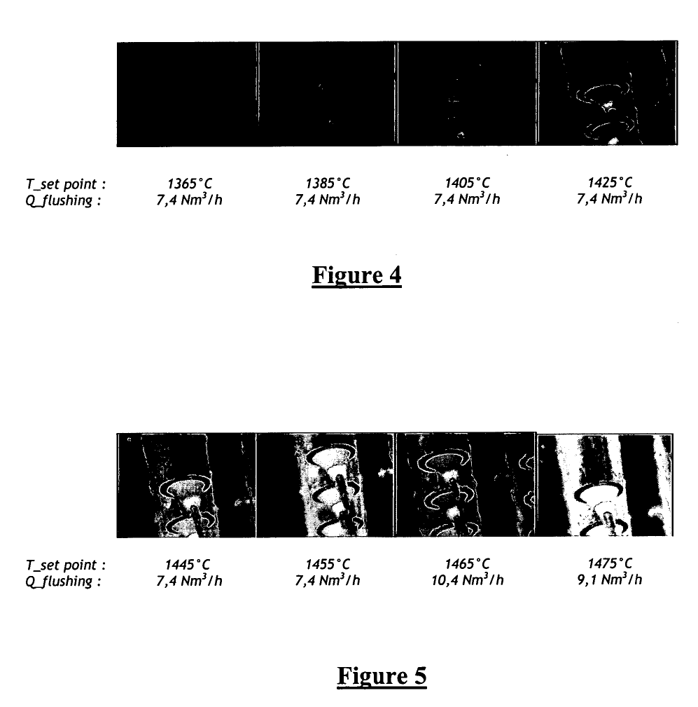

FIGS. 4 and 5 are photographs illustrating the change in shape of the cone for various blowing fluid temperatures and flow rates, for two different positions of the cone on the fin.

FIG. 1 depicts the heat exchanger device 1 according to the invention. This device essentially comprises a plurality of fins 2 (to make the drawing easier to understand, just two fins have been depicted) and a manifold 3. Each of the fins, at one of its free ends, is secured by known means (welding, brazing, bonding) to one of the walls of the manifold so as to form a comb in this particular embodiment. It goes without saying that this heat exchanger device may adopt different configurations other than that of a comb; it may thus be in the form of a frame or portion of a frame incorporating said fins.

This heat exchanger device is intended to be positioned underneath and near the bottom of a bushing in a fiberizing booth. The spacing between the fins corresponds roughly to the separation of the fiberizing nozzles situated at the bottom of the bushing so that the filaments of molten glass pass more or less in a plane positioned such that it is coplanar with and equidistant between two juxtaposed fins.

Each fin is of roughly parallelepipedal shape with a tubular cross section and has short and long walls 4, 5 parallel to one another in pairs, the long walls 4, 5, however, being intended to face the filaments. In the example depicted in FIG. 1, the fin is of rectangular cross section and the interior passage 6 defined between the walls 4, 5 of the fin allows a compressed blowing fluid (such as air or nitrogen for example) to pass. This blowing fluid is subjected beforehand to a treatment to remove any harmful particles which might tend to clog the pores of the fin (air from which oil and dust have been removed). The blowing fluid may also result from the vaporization of a fluid initially in the liquid state (water, alcohol, ethylene glycol, acetone, this fluid being used pure or as a mixture), this vaporization taking place within the fin: this type of blowing fluid is advantageous because it makes it possible to use the latent heat of vaporization of the fluid. Each of the passages of each of the fins is connected to the manifold when the comb is produced, the comb itself being provided at the manifold with a device for connection to the blowing fluid distributed to the fiberizing booth.

According to a first embodiment of the invention, the fin is obtained by sintering a metal powder, particularly a mixture of powdered stainless steel, brass and nickel, the particle size of which is smaller than 100 μm and preferably lies in the range from 10 to 80 μm.

The open porosity sought with this type of powder is in the range between 5 and 30% and preferably between 10 and 25% and more preferably still between 15 and 20% and more or less around 17%.

The thickness of the tubular walls of the fin is more or less around 1 mm.

Using these fins it has been possible to measure, across each to the long faces of the fin, a permeability to air measured at 0.5 bar and 0° C. in the range from 300 to 1500 Sm³/h/m², particularly in the range from 300 to 800 Sm³/h/m² and preferably in the range from 500 to 600 Sm³/h/m², which represents flow speeds of between 0.08 and 0.2 m/s in the case of the first range of permeability values. The operating pressure of the fin and therefore of the comb which incorporates at least one of these fins is between 0.1 and 6 bar, preferably between 0.2 and 4 bar.

According to a second embodiment, the fin is obtained by laminating a metal gauze, between at least 3 and 18 layers, particularly between at least 3 and 6 layers of gauze assembled by compression or by sintering. The mesh size of the gauze lies more or less in the range from 1 to 30 μm.

The open porosity sought with this lamination of metal gauze lies in the range from 5 to 30% and preferably between 10 and 25% and more preferably still between 15 and 20%.

Likewise, using these fins, it has been possible to measure on each of the long faces of the fin a permeability to air at 0.5 bar and at 0° C. in the range from 300 to 1500 Sm³/h/m², particularly in the range from 300 to 800 Sm³/h/m², preferably in the range from 500 to 600 Sm³/h/m², which represents flow speeds of between 0.08 and 0.2 m/s (in the case of the first range of permeability values). The operating pressure of the fin and therefore of the comb incorporating at least one of these fins is between 0.1 and 6 bar, preferably between 0.2 and 4 bar.

Using this method of fabrication it has been possible to determine a certain number of characteristics regarding the flow of the blowing fluid through each side of the long walls of the fin.

Hence, FIG. 2 shows the change in throughput of the bushing as a function of the increase in the set point temperature of the bottom of the bushing for various blowing fluid flow rates through a wall of the fin. The data relating to the bushing illustrated in FIG. 2 et seq. are given by way of indication, the bushing in question being a laboratory bushing fed with alkali-resistant glass cullet.

The throughput of the bushing increases progressively as the bushing set point temperature increases. At the maximum temperature (1475° C.) that the bushing can withstand, by adjusting the blowing flow rate a maximum bushing throughput of 47.2 kg/day is observed. This is 21% higher than the maximum throughput that can be achieved with conventional fins (39.1 kg/day). The gain in throughput using the blowing fins is therefore very great. It should be pointed out that this maximum throughput is limited rather by the maximum set point temperature of the bushing (1475° C.) at which temperature the alloy of which the bushing is made melts.

The increase in the throughput of the bushing is not only dependent on the temperature of the blowing fluid, which provides cooling of the fins by convection. When the blowing fluid passes through the porous walls of the fins, the fresh blown fluid (entering the fins at 20° C.) efficiently cools the fins and is able to keep the fin temperature relatively low dependent on the blowing flow rate. This low temperature of the blowing fins allows at the same time an increase in the radiation heat exchange between the cones and the blowing fins. In order to give an idea of the cooling capability of the blowing fins, FIG. 3 sets out the thermal power that can be removed by a blowing fin as a function of the blowing fluid flow rate, assuming an air temperature around the cones of 100° C., 200° C. and 300° C., respectively. It can be pointed out that, if a fin blows a blowing fluid (in this instance air) at a flow rate of 5 m³/h, it is able to remove 120 W at 100° C., 280 W at 200° C. and 450 W at 300° C. This data should be compared with the cooling capability of a fin known from the prior art, the latter cooling capability being limited to around 100 watts.

Although increasing the throughput of a bushing is one of the users' main objectives it is nevertheless important not to lose sight of the fact that this increase must not be had at the expense of the stability of the bushing, and mainly the stability of the cones formed underneath the bottom of the bushing. Now, cone stability is dependent on the cone temperature, this temperature itself being dependent on the flow rate of the blowing fluid and on its homogeneity.

As can be seen in FIGS. 4 and 5, it is observed that when the set point temperature increases the cone depicted in FIG. 4 becomes increasingly hot. It progressively regains its volume and becomes increasingly straight. In the case of the cone depicted in FIG. 5, the blowing by the fins is more gentle and the cone is wider. When the set point temperature increases, the cone enlarges and begins to spill over around the nozzle. Upwards of 1465° C., the air flow rate has to be increased in order to stabilize the fiberizing. An extremely advantageous phenomenon is observed: the cone is very stable and there is practically no longer any of the pulsation of the cone that is found with fins of the prior art. Fiberizing can be achieved stably even when the cone spills over around the nozzle. When the cone is extremely hot, pulsation reappears and a small increase in blowing is immediately able to calm this instability. In addition, during tests, it was found that the shape of the cones could very easily and very flexibly be varied by altering the flow rate blown through the fins. This offers the advantage of a great potential for adjusting the thickness of the filament.

Of course, other embodiments not depicted in the figures may be conceived of, particularly in terms of the shapes, cross sections and outlines of the fins. Likewise, in terms of the heat exchanger device and according to an alternative form, also not depicted in the figures, provision is made for a cooling circuit to be incorporated in the manifold in order to remove additional heat energy by circulating a heat transfer fluid (such as water for example).

The invention described above offers numerous advantages:
It increases the cooling of the cone of glass and the bottom of the bushing by the blowing of the fins. This makes it possible to widen the fiberizing temperature range. Fiberizing becomes less critical and more stable;
It avoids the deposition of airborne substances on the surfaces of the fins by blowing. It makes it possible to provide fins that are more efficient and more economical for the fiberizing of glass filaments. The production of filaments can thus mainly or entirely dissociate itself from the disruption of periodic cleaning of the fins, thus improving productivity;
It provides fins the heat absorption rate of which can be adjusted, allowing optimum heat absorption under all operating conditions;
It supplies an additional means for precisely adjusting the thickness of the filaments by adjusting the blowing pressure;
It immediately, using fresh air blown through the fins, compensates for the air sucked out of the fiberizing region by the drawing of the filaments, making it possible to reduce or prevent the ingress of air from the outside toward the inside of the web of filaments in this sensitive region. Fiberizing can thus dissociate itself from the effects of turbulent or transient disturbances in the flow of air outside the web of filaments (for example: the movement of dust). The air flow conditions in the fiberizing region become more stable and easier to control.
With uniform and homogeneous blowing fins it is therefore possible to fiberize at a higher temperature and to reduce the fiberizing tension while at the same time maintaining the stability of the bushing.

1-13. (canceled)

14. A heat exchanger device comprising:
at least one fin including means for blowing a fluid,
wherein the blowing means are uniform and include at least one wall of the fin, the at least one wall having open porosity.

15. Heat exchanger device as claimed in claim 14, wherein the open porosity of the wall is at least one of between 5 and 30%, between 10 and 25%, and between 15 and 20%.

16. Heat exchanger device as claimed in claim 14, wherein the fin is of parallelepipedal overall shape and tubular cross section and has a permeability measured with air at a pressure of 0.5 bar and at 0° C. lying at least one of in a range from 300 to 1500 Sm³/h/m² and in a range from 300 to 800 Sm³/h/m².

17. The heat exchanger device as claimed in claim 16, wherein permeability measured with air at a pressure of 0.5 bar and at 0° C. lies in a range from 500 to 600 Sm³/h/m².

18. The heat exchanger device as claimed in claim 14, wherein a blowing fluid velocity field is symmetric across the at least one open porosity wall.

19. The heat exchanger device as claimed in claim 14, wherein the at least one wall of the heat exchanger device is obtained by sintering a metal powder.

20. The heat exchanger device as claimed in claim 19, wherein the metal powder is based on a mixture of powdered stainless steel, brass and nickel, with at least one of a particle size smaller than 100 μm and a particle size lying within a range from 10 to 80 μm.

21. The heat exchanger device as claimed in claim 20, wherein the open porosity is of an order of 17%.

22. The heat exchanger device as claimed in claim 14, wherein the at least one wall of the heat exchanger device is obtained by laminating a metal gauze.

23. The heat exchanger device as claimed in claim 22, wherein a lamination comprises at least one of 3 to 18 and 3 to 6 layers of metal gauze.

24. The heat exchanger device as claimed in claim 14, wherein the fluid is air at a pressure of at least one of between 0.1 and 6 bar and between 0.2 and 4 bar.

25. The heat exchanger device as claimed in claim 14, wherein the blowing fluid results from vaporization within the fin of a fluid that was initially in a liquid state.

26. The heat exchanger device as claimed in claim 14, further comprising an auxiliary cooling circuit.
